(19) United States
(12) Patent Application Publication
(10) Pub. No.: US 2013/0135231 A1
(43) Pub. Date: May 30, 2013

(54) TOUCH SCREEN AND METHOD OF MANUFACTURING THE SAME

(71) Applicant: SAMSUNG ELECTRONICS CO. LTD., Suwon-si (KR)

(72) Inventors: Jaehyung PARK, Guri-si (KR); Minuk KIM, Seoul (KR); Kyungmin LEE, Seoul (KR)

(73) Assignee: SAMSUNG ELECTRONICS CO. LTD., Suwon-si (KR)

(21) Appl. No.: 13/680,662

(22) Filed: Nov. 19, 2012

(30) Foreign Application Priority Data
Nov. 30, 2011 (KR) 10-2011-0127024

(51) Int. Cl. G06F 1/16; G06F 3/041

(52) U.S. Cl. CPC G06F 1/16; G06F 3/041
USPC 345/173; 29/825

(57) ABSTRACT

A touch screen and a method of manufacturing the same are provided. The touch screen includes a glass substrate, a first plurality of sensing electrodes arranged in a multi-row and a multi-column layout on the glass substrate and in which first sensing electrodes positioned in a same row or a same column are directly connected, a plurality of second sensing electrodes independently formed and arranged in a multi-row and a multi-column layout on the glass substrate, a bridge for electrically connecting two of the second sensing electrodes positioned in a same column or a same row, and an insulating portion positioned between the bridge and at least one of the first sensing electrodes in order to prevent the first sensing electrode and the second sensing electrode from electrically contacting, wherein the bridge is made of silver.

### PRIORITY

This application claims the benefit under 35 U.S.C. §119(a) of a Korean patent application filed on Nov. 30, 2011 in the Korean Intellectual Property Office and assigned Serial No. 10-2011-0127024, the entire disclosure of which is hereby incorporated by reference.

### BACKGROUND OF THE INVENTION

1. Field of the Invention

The present invention relates to a touch screen and a method of manufacturing the same. More particularly, the present invention relates to a touch screen and a method of manufacturing the same that improve a visibility problem in which a bridge for connecting sensing electrodes for detecting a touch is viewable by a user.

2. Description of the Related Art

Based on the convenience it provides as an input device, there is significant interest in the use and development of a touch screen. Recently, a Direct Patterned Window (DPW) type touch screen, in which a touch sensor is directly formed in a glass substrate, has gained attention. In the DPW type touch screen, a transparent electrode is coated on a glass substrate, and, by patterning the transparent electrode through a photo process, an X-axis sensing electrode is formed, a Y-axis sensing electrode is formed to be separated into islands, an insulating film is formed in areas in which the Y-axis sensing electrodes and the X-axis sensing electrodes overlap, and a transparent conducting film (bridge) for connecting the Y-axis sensing electrodes is formed.

FIG. 1 is a diagram illustrating a structure of a touch screen having a DPW type 2-layer structure according to the related art, and FIG. 2 is a cross-sectional view of a DPW type touch screen taken along line A-A′ of FIG. 1 according to the related art.

Referring to FIGS. 1 and 2, on a substrate 7, X-axis sensing electrodes 1 and 2 of the DPW type touch screen are connected to each other, and Y-axis sensing electrodes 3 and 4 are separated to form individual islands. To connect the separated Y-axis sensing electrodes 3 and 4, a bridge 5 is provided. Further, in order to prevent the X-axis sensing electrodes 1 and 2 and the Y-axis sensing electrodes 3 and 4 from electrically contacting, an insulating portion 6 is positioned between the bridge 5 and the X-axis sensing electrodes 1 and 2. The bridge 5 may be made of a metal such as Indium Tin Oxide (ITO) or copper. The bridge 5 may generally have a width D of 10 to 300 μm using a photo process.

In a DPW type touch screen having a structure as illustrated in FIGS. 1 and 2, a reflectivity of an area at which the bridge 5 and the insulating portion 6 are positioned and a reflectivity of another area (having no insulating portion 6) are different. Due to such a reflectivity difference, even if a DPW type touch screen performs index matching, light is reflected at a specific angle and thus a problem that the bridge 5 is viewable by a user exists. Thereby, the DPW type touch screen does not provide a clear picture quality to a user.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a touch screen and a method of manufacturing the same that improve a visibility problem in which a bridge for connecting sensing electrodes for detecting a touch is viewable by a user.

Another aspect of the present invention is to provide a touch screen and a method of manufacturing the same that improve a visibility problem by forming the bridge with silver having relatively low reflectivity and high viscosity.

In accordance with an aspect of the present invention, a touch screen is provided. The touch screen includes a glass substrate, a plurality of first sensing electrodes arranged in a multi-row and a multi-column layout on the glass substrate and in which first sensing electrodes positioned in a same row or a same column are directly connected, a plurality of second sensing electrodes independently formed and arranged in a multi-row and a multi-column layout on the glass substrate, a bridge for electrically connecting two of the second sensing electrodes positioned in a same column or a same row, and an insulating portion positioned between the bridge and at least one of the first sensing electrodes in order to prevent the first sensing electrode and the second sensing electrode from electrically contacting, wherein the bridge is made of silver.

In accordance with another aspect of the present invention, a method of manufacturing a touch screen is provided. The method includes, preparing a glass substrate, forming a plurality of first sensing electrode arranged in a multi-row and a multi-column layout on the glass substrate and in which first sensing electrodes positioned in a same row or a same column are directly connected and a plurality of second sensing electrodes that are independently formed, forming an insulating portion for blocking an electrical connection between at least one of the first sensing electrodes and at least one of the second sensing electrodes, and forming a bridge for electrically connecting at least two of the independently formed second sensing electrodes positioned in a same column or a same row, wherein the bridge is made of silver.

In accordance with another aspect of the present invention, a method of manufacturing a touch screen is provided. The method includes preparing a glass substrate, forming a bridge for electrically connecting at least two second sensing electrodes which are independently formed and positioned in a same column or a same row among a plurality of second sensing electrodes arranged in a multi-row and a multi-column layout on the glass substrate, forming an insulating portion for blocking an electrical contact between the bridge and a plurality of first sensing electrodes arranged in a multi-row and a multi-column layout on the glass substrate and in which first sensing electrodes positioned in a same row or a same column are directly connected, and forming the plurality of first sensing electrodes and the plurality of second sensing electrodes on the glass substrate, wherein the bridge is made of silver.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a structure of a touch screen having a Direct Patterned Window (DPW) type 2-layer structure according to the related art;

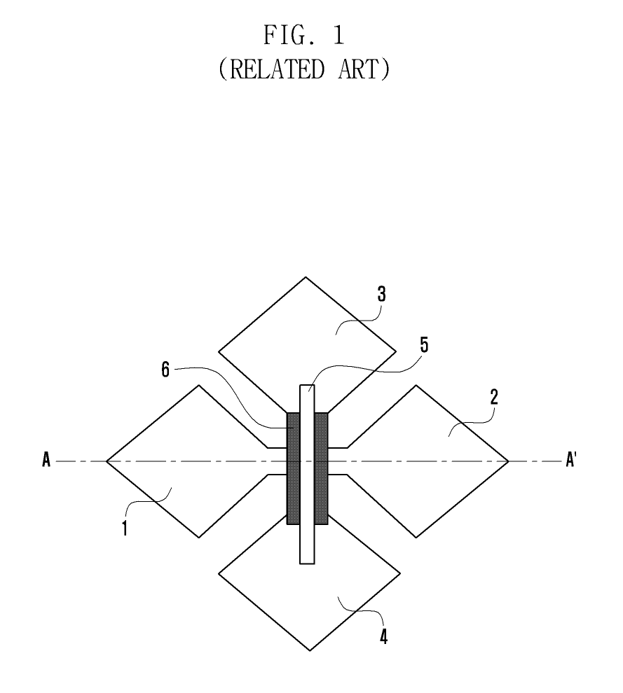

FIG. 2 is a cross-sectional view of a DPW type touch screen taken along line A-A′ of FIG. 1 according to the related art;

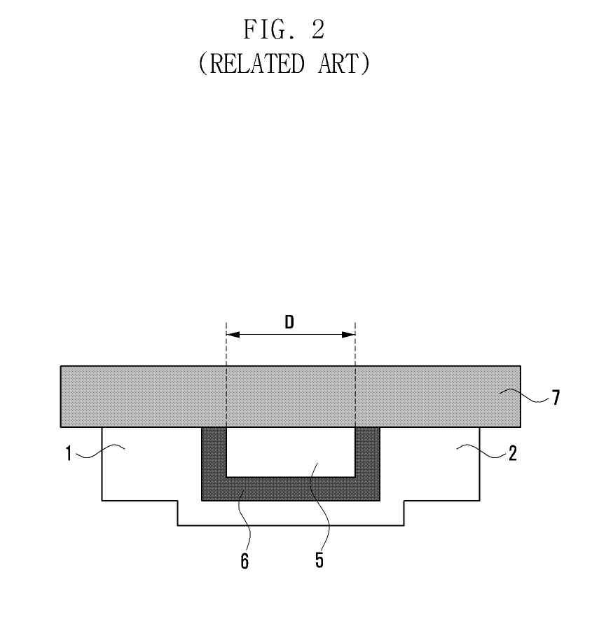

FIG. 3 is a diagram illustrating a structure of a touch screen according to an exemplary embodiment of the present invention;

FIG. 4 is a diagram illustrating a method of manufacturing a touch screen according to an exemplary embodiment of the present invention; and

FIG. 5 is a diagram illustrating a method of manufacturing a touch screen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

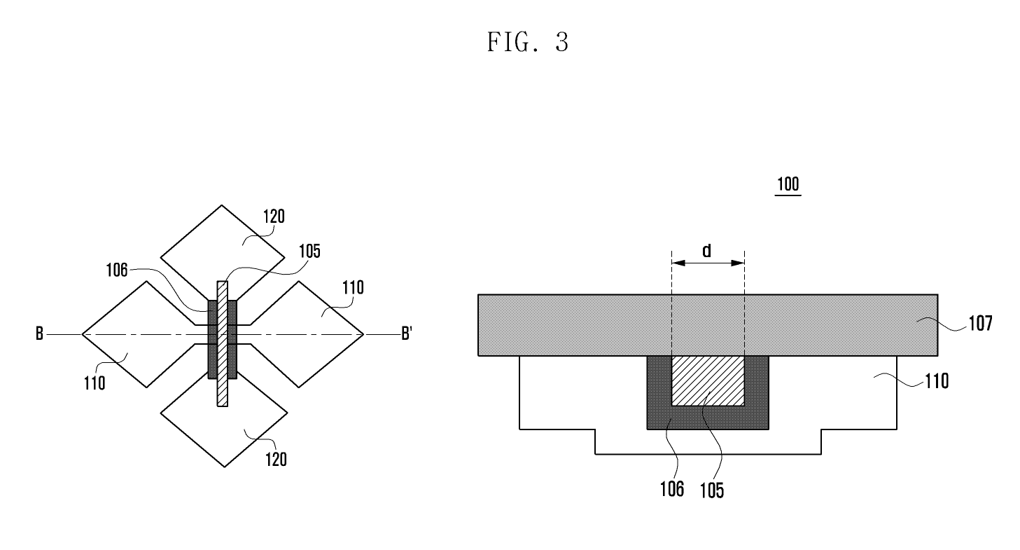

FIG. 3 is a diagram illustrating a structure of a touch screen according to an exemplary embodiment of the present invention.

Referring to FIG. 3, a touch screen 100 includes a bridge 105, an insulating portion 106, a glass substrate 107, a first sensing electrode 110, and a second sensing electrode 120.

The glass substrate 107 may be made of tempered glass. A touch detection means for detecting a touch is positioned at a lower surface of the glass substrate 107. In order to recognize a two-dimensional coordinate, the touch detection means includes the first sensing electrode 110 and the second sensing electrode 120. For example, the first sensing electrode 110 may be a touch sensor for detecting an X-axis coordinate, and the second sensing electrode 120 may be a touch sensor for detecting a Y-axis coordinate.

The first sensing electrode 110 and the second sensing electrode 120 may be formed with a plurality of sensing electrodes. In this case, sensing electrodes of the first sensing electrode 110 and sensing electrodes of the second sensing electrode 120 are arranged in multi-row and multi-column layouts, and sensing electrodes positioned at the same line may be electrically connected. For example, as shown in FIG. 3, the sensing electrodes of the first sensing electrode 110 positioned at the same row may be directly connected, and the sensing electrodes of the second sensing electrode 120 positioned at the same column may be connected through the bridge 105.

The bridge 105 electrically connects the sensing electrodes of the second sensing electrode 120. That is, the bridge 105 may be made of a conductive material. In an exemplary implementation, the bridge 105 is made of silver having relatively low reflectivity, high viscosity, and high electrical conductivity. In this case, in order to improve a visibility problem as described above in the related art, it is preferable that the bridge 105 has a minimum width d that can stably provide an electrical connection. For example, it is preferable that a width d of the bridge 105 is 5 μm or less. In order to minimize the width d and to provide a stable electrical connection, the bridge 105 may have a mesh structure or be formed with a nanowire. In an exemplary implementation, if the bridge 105 is formed with silver having relatively high viscosity and high electrical conductivity, a width d of the bridge 105 can be remarkably reduced, compared with the width of the bridge of the related art. Thereby, in the present exemplary embodiment and as compared with the bridge 105 that is made of Indium Tin Oxide (ITO) or copper in the related art, the visibility problem suffered by the related art in which the bridge 105 is viewable by a user can be improved. Further, as silver has low reflectivity, a visibility problem of a touch screen of the related art can be further improved.

The insulating portion 106 is made of a non-electrically conductive material that does not allow electricity to pass through and is formed between the first sensing electrode 110 and the second sensing electrode 120. That is, the sensing electrodes of the first sensing electrode 110 are connected to each other while the sensing electrodes of the second sensing electrode 120 are formed as islands and are electrically connected by the bridge 105. Because the bridge 105 overlaps the connection of the sensing electrodes of the first sensing electrode 110, the insulating portion 106 is provided in order to prevent the first sensing electrode 110 and the second sensing electrode 120 from being electrically connected. Furthermore, as a width d of the bridge 105 decreases, a width of the insulating portion 106 also decreases. In this way, in the present exemplary embodiment, in the touch screen 100, as a size of the bridge 105 and the insulating portion 106 decreases, a visibility problem in which the bridge 105 is viewable by a user can be improved. In an exemplary implementation, the insulating portion 106 may be an insulating film.

In the foregoing exemplary embodiment, it is described that the sensing electrodes of the first sensing electrode 110 are directly connected, and the sensing electrodes of the second sensing electrode 120 are connected through the bridge 105. However, the sensing electrodes of the first sensing electrode 110 may be connected through the bridge 105 and the sensing electrodes of the second sensing electrode 120 may be directly connected.

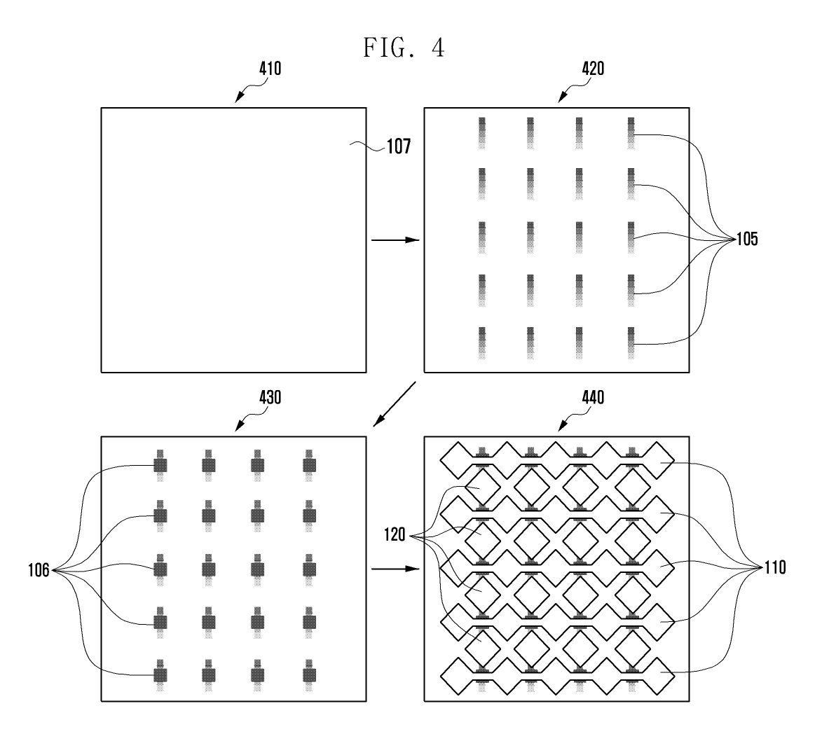

FIG. 4 is a diagram illustrating a method of manufacturing a touch screen according to an exemplary embodiment of the present invention.

Referring to FIGS. 3 and 4, in a method of manufacturing the touch screen 100 according to an exemplary embodiment of the present invention, a glass substrate 107 is prepared, as shown by an identification symbol 410. Thereafter, a plurality of bridges 105 is formed on the glass substrate 107, as shown by an identification symbol 420. The bridges 105 are disposed so as to be arranged in multi-row and multi-column layouts and may be made of a conductive material for electrically connecting the sensing electrodes of the independently formed second sensing electrode 120. More particularly, in the present exemplary embodiment, the bridge 105 may be made of silver having relatively low reflectivity, high viscosity, and high electrical conductivity and have a width of 5 μm or less. This improves a conventional visibility problem and provides a stable electrical connection. For this, the bridge 105 may be formed with a mesh structure or a nanowire.

When the bridge 105 is formed, the bridge 105 is arranged in multi-row and multi-column layouts on the glass substrate 107, as shown by an identification symbol 430 and may have an insulating portion 106 formed thereon for blocking an electrical contact between the first sensing electrode 110, in which a plurality of sensing electrodes positioned at the same line are directly connected, and the bridge 105. That is, the insulating portion 106 may be formed in an area in which the sensing electrodes of the first sensing electrode 110 and the sensing electrodes of the second sensing electrode 120 are overlapped.

When forming of the insulating portion 106 is complete, the first sensing electrode 110 and the second sensing electrode 120 for detecting a touch are formed on the glass substrate 107, as shown by an identification symbol 440. Here, as shown by the identification symbol 440, the sensing electrodes of the first sensing electrode 110 and the sensing electrodes of the second sensing electrode 120 are arranged in multi-row and multi-column layouts. In this case, the sensing electrodes of the first sensing electrode 110 positioned at the same row are directly connected, and the sensing electrodes of the second sensing electrode 120 positioned at the same column are connected through the bridge 105.

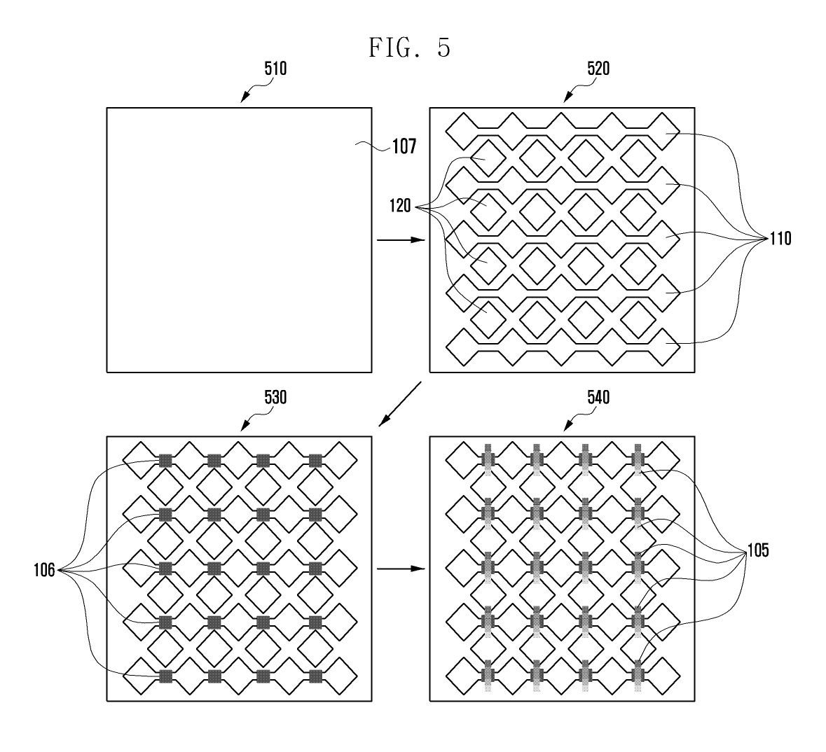

FIG. 5 is a diagram illustrating a method of manufacturing a touch screen according to an exemplary embodiment of the present invention.

Referring to FIGS. 3 and 5, in a method of manufacturing a touch screen 100 according to an exemplary embodiment of the present invention, a glass substrate 107 is prepared, as shown by an identification symbol 510. Thereafter, a first sensing electrode 110 and a second sensing electrode 120 are formed in the glass substrate 107, as shown by an identification symbol 520. Here, the first sensing electrode 110 and the second sensing electrode 120 are formed with a plurality of sensing electrodes. The plurality of sensing electrodes are arranged in multi-row and multi-column layouts, and the sensing electrodes of the first sensing electrode 110 positioned at the same row are directly electrically connected. The sensing electrodes of the second sensing electrode 120 may be independently formed as islands.

When forming of the first sensing electrode 110 and the second sensing electrode 120 is complete, in order to block an electrical connection of the sensing electrodes of the first sensing electrode 110 and the sensing electrodes of the second sensing electrode 120, the insulating portion 106 is formed in an area in which the sensing electrodes of the first sensing electrode 110 and the sensing electrodes of the second sensing electrode 120 are overlapped, as shown by an identification symbol 530.

When forming of the insulating portion 106 is complete, a plurality of bridges 105 for electrically connecting the sensing electrodes of the second sensing electrode 120 is formed in the glass substrate 107, as shown by an identification symbol 540. In an exemplary implementation, the bridge 105 may be made of silver having relatively low reflectivity, high viscosity, and high electrical conductivity and having a width of 5 μm or less. This improves a conventional visibility problem and provides a stable electrical connection. For this, the bridge 105 may have a mesh structure or is formed with a nanowire.

The forming of the first sensing electrode 110, the second sensing electrode 120, the bridge 105, and the insulating portion 106 may be performed with various methods such as printing, coating, and deposition.

Further, in FIGS. 4 and 5, it is described that the sensing electrodes of the first sensing electrode 110 are directly connected and the sensing electrodes of the second sensing electrode 120 are electrically connected through the bridge 105. However, the present invention is not limited thereto. For example, in another exemplary embodiment of the present invention, sensing electrodes of the first sensing electrode 110 may be electrically connected through the bridge 105, and sensing electrodes of the second sensing electrode 120 may be directly connected.

As described above, according to exemplary embodiments of the present invention, by forming the bridge 105 with silver having relatively high viscosity and high electrical conductivity, a width d of the bridge 105 can be remarkably reduced, compared with a bridge width of the related art. Thereby, in exemplary embodiments of the present invention, by forming a bridge with silver, a visibility problem of the related art in which the bridge 105 is viewable by a user can be improved. Further, the visibility problem can be further improved with the use of low reflectivity silver. As described above, in a touch screen and a method of manufacturing the same according to exemplary embodiments of the present invention, a visibility problem in which a bridge for connecting sensing electrodes is viewable by a user can be improved. Therefore, an exemplary touch screen according to the present invention can provide a clearer image.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch screen comprising:
a glass substrate;
a plurality of first sensing electrodes arranged in a multi-row and a multi-column layout on the glass substrate and in which first sensing electrodes positioned in a same row or a same column are directly connected;
a plurality of second sensing electrodes independently formed and arranged in a multi-row and a multi-column layout on the glass substrate;
a bridge for electrically connecting two of the second sensing electrodes positioned in a same column or a same row; and
an insulating portion positioned between the bridge and at least one of the first sensing electrodes in order to prevent the first sensing electrode and the second sensing electrode from electrically contacting,
wherein the bridge is made of silver.

2. The touch screen of claim 1, wherein the bridge has a mesh structure.

3. The touch screen of claim 1, wherein the bridge comprises a nanowire.

4. The touch screen of claim 1, wherein the bridge has a minimum width that can stably provide an electrical connection.

5. The touch screen of claim 4, wherein a width of the bridge is 5 μm or less.

6. The touch screen of claim 1, wherein the insulating portion comprises an insulating film.

7. A method of manufacturing a touch screen, the method comprising:
preparing a glass substrate;
forming a plurality of first sensing electrodes arranged in a multi-row and a multi-column layout on the glass substrate and in which first sensing electrodes positioned in a same row or a same column are directly connected and a plurality of second sensing electrodes that are independently formed;
forming an insulating portion for blocking an electrical connection between at least one of the first sensing electrodes and at least one of the second sensing electrodes; and
forming a bridge for electrically connecting at least two of the independently formed second sensing electrodes positioned in a same column or a same row,
wherein the bridge is made of silver.

8. The method of claim 7, wherein the bridge has a minimum width that can stably provide an electrical connection.

9. The method of claim 8, wherein a width of the bridge is 5 μm or less.

10. The method of claim 7, wherein the bridge has a mesh structure.

11. The method of claim 7, wherein the bridge comprises a nanowire.

12. The method of claim 7, wherein the forming of the insulating portion comprises forming an insulating film.

13. A method of manufacturing a touch screen, the method comprising:
preparing a glass substrate;
forming a bridge for electrically connecting at least two second sensing electrodes which are independently formed and positioned in a same column or a same row among a plurality of second sensing electrodes arranged in a multi-row and a multi-column layout on the glass substrate;
forming an insulating portion for blocking an electrical contact between the bridge and a plurality of first sensing electrodes arranged in a multi-row and a multi-column layout on the glass substrate and in which first sensing electrodes positioned in a same row or a same column are directly connected; and
forming the plurality of first sensing electrodes and the plurality of second sensing electrodes on the glass substrate,
wherein the bridge is made of silver.

14. The method of claim 13, wherein the bridge has a minimum width that can stably provide an electrical connection.

15. The method of claim 14, wherein a width of the bridge is 5 μm or less.

16. The method of claim 13, wherein the bridge has a mesh structure.

17. The method of claim 13, wherein the bridge comprises a nanowire.

18. The method of claim 13, wherein the forming of the insulating portion comprises forming an insulating film.
